(19) United States
(12) Patent Application Publication
(10) Pub. No.: US 2007/0076084 A1
(43) Pub. Date: Apr. 5, 2007

(54) Reimageable printing member

(75) Inventors: Gabriel Iftime, Mississauga (CA); Paul F. Smith, Oakville (CA); Peter M. Kazmaier, Mississauga (CA); Hadi K. Mahabadi, Mississauga (CA)

Correspondence Address: OLIFF & BERRIDGE, PLC., P.O. BOX 19928, ALEXANDRIA, VA, 22320, US

(73) Assignee: Xerox Corporation, Stamford, CT (US)

(21) Appl. No.: 11/239,072

(22) Filed: Sep. 30, 2005

(51) Int. Cl. B41J 2/385

(52) U.S. Cl. 347/111

(57) ABSTRACT

A reimageable printing member such as a printing plate for use in flexography, includes a layer having a multiplicity of channels therein. The layer has an open side to which the multiplicity of channels are open. The reimageable printing member further includes a filed generator such as an electrode or a magnetic field generator associated with the multiplicity of channels and generating an electric and/or magnetic field. The multiplicity of channels are individually addressable, thereby permitting the field to be applied to selected ones of the multiplicity of channels so that the marking material within such selected channels can be manipulated to move out of the channel and onto an image receiving substrate brought into contact with the open side of the layer, thereby forming an image on the substrate.

### CROSS-REFERENCE TO RELATED APPLICATION

Disclosed in commonly assigned U.S. patent application Ser. No. ______(entitled Reimageable Printing Member; Gabriel Iftime; Attorney Docket No. 124349), filed on even date herewith and incorporated herein by reference in its entirety, is a reimageable printing member comprising a multiplicity of vertically expandable units, wherein each of the vertically expandable units includes a material that undergoes a dimension change upon exposure to an applied stimulus, and wherein the multiplicity of vertically expandable units are individually addressable by a stimulus that initiates the change in dimension in the material.

### BACKGROUND

This disclosure relates to a reimageable printing member, for example a reimageable flexographic printing plate, and a method of forming images with such reimageable printing member.

The flexographic printing market is significant. Current examples of printing done by the flexography process include printing decorated toilet tissue, bags, corrugated board and other materials such as foil, cellophane, polyethylene and other plastic films.

In flexography, printing is done by using plates that contain the image to be transferred onto a substrate in the form of raised images upon the plate surface. Specifically, the flexographic plate surface contains a permanently raised image, i.e., a raised reverse image of the image to be formed on the substrate, usable for printing only a single same image on substrates. When a new or different image is needed, a new plate is fabricated and the previously used plate is stored or disposed. High cost associated with plate fabrication, as well as with storage of a large number of plates, requires flexographic printing jobs to be of the order of millions of identical prints per plate in order for the process to be cost effective.

### REFERENCES

WO 98/53370 describes a printing plate including a support assembly and a relief imaged surface formed directly on the surface of the support assembly by digital photopolymerization. The printing plate is formed by providing a liquid photopolymer on the surface of the support assembly and irradiating the polymer with a source of actinic radiation to form the relief image. The printing plate is reimageable and may be used in flexographic printing processes as well as other printing applications.

JP 11-258785 describes a plate including a cis-trans photoisomerization azobenzene layer 35 formed on a supporting body 34. Layer 35 is contracted as a whole by being uniformly irradiated with ultraviolet rays first. Next, it is returned to an original trans state by being irradiated with visible light 36 being stimulation inputted based on image information. Therefore, only the part 37 thereof irradiated with the light 36 is swollen. Surface recessed and projection patterns obtained based on the image information are formed at the surface of the layer 35. At a next step, the uniformly formed thin layer of the color material 38 is closely brought into contact with a color grain supply supporting body 39 and the grains 38 are attached to the swollen part 37 by attaching force such as adhesive strength to form an image area. Then, the color grains in the image area are transferred to a medium to be recorded 40.

### SUMMARY

There is a need for a printing member in which the image on the member can be changed without having to dispose of the plate.

Accordingly, described herein is a reimageable printing member, for example for use in flexography, which includes a layer having a multiplicity of channels therein. The layer has an open side to which the multiplicity of channels open. The reimageable printing member further includes a field generator such as an electrode or a magnetic field generator associated with the multiplicity of channels and generating a field such as an electric field and/or magnetic field. The multiplicity of channels are individually addressable, thereby permitting the field to be applied to selected ones of the multiplicity of channels so that marking material within such selected channels can be manipulated to move out of the channel and onto an image receiving substrate brought into location over or contact with the open side of the layer.

In embodiments, described is a reimageable printing member comprising a layer having a multiplicity of channels therein, the layer having an open side to which the multiplicity of channels are open, and wherein the reimageable printing member further includes a field generator comprised of an electrode or a magnetic field generator, the field generator associated with the multiplicity of channels and generating an electric field and/or magnetic field, and wherein the multiplicity of channels are individually addressable by the field generator.

In further embodiments, described is a reimageable printing member comprising a layer having a multiplicity of channels therein, wherein the channels are open on one side of the layer, and wherein the layer includes, at an opposite side from the open side of the layer, an electrode unit or a magnetic field generating unit.

In still further embodiments, described is a method of forming an image with a reimageable printing member comprising a layer having a multiplicity of channels therein, the layer having an open side to which the multiplicity of channels are open, and wherein the reimageable printing member further includes a field generator comprised of an electrode or a magnetic field generator, the field generator associated with the multiplicity of channels and generating an electric field and/or magnetic field, and wherein the multiplicity of channels are individually addressable by the field generator, the method comprising: providing the multiplicity of channels with a marking material; generating an electric field and/or magnetic field with the field generator associated with selected ones of the multiplicity of channels that correspond to an image to be formed by the reimageable printing member, wherein generation of the field manipulates the marking material in the selected channels to move toward an open side of the layer; and forming the image on an image receiving substrate brought into contact with or located over the reimageable printing member.

By being reimageable, the printing member may reduce the number of members that need to be fabricated. Such a reimageable member may also reduce the total printing time because there is no more need to replace a used member with a new one before continuing printing. The reimageable member may also enable development of a wide body of direct marking engines for printing documents.

### BRIEF DESCRIPTION OF THE DRAWINGS

FIG. 1 illustrates a layer of a reimageable printing member including a multiplicity of holes or channels therein.

FIG. 2 illustrates a flexographic printing system using the reimageable printing member.

FIG. 3 illustrates one method of filling the channels of the reimageable printing member with marking materials.

FIG. 4 illustrates a further method of filling the channels of the reimageable printing member with marking materials.

FIG. 5 illustrates a transfer roll that may be used in providing marking materials to the reimageable printing member.

### EMBODIMENTS

The printing member described herein is reimageable. In embodiments, reimageable refers to reuse of the same printing member in forming one or more different images. For example, in embodiments reimageable indicates that the member is not restricted to use in forming only a single image until discarded, and is capable of being used in forming any number of different images during the member's useful life. The member may thus be reimageable in not being restricted to use in forming only a single image. As such, the same printing member can be used to form multiple different images.

The reimageable printing member is, for example, a reimageable printing plate such as a reimageable flexographic printing plate.

The reimageable printing member includes a layer having a multiplicity of channels such as holes or openings. Multiple layers encompassing the channels may be used. The channels are open to at least an imaging surface, or side, of the layer, which is the side that will face an image receiving substrate when forming an image on the image receiving substrate using the printing member.

Each of the channels may be described as corresponding to a pixel of an image to be formed by the printing member. While any size and shape of the channels may be used, and any spacing between channels may be used, in embodiments the channels have an average width or diameter of, for example, from about 1 μm to about 200 μm, such as from about 1 μm to about 100 μm or from about 1 μm to about 50 μm or to about 10 μm. In addition, as each channel location represents a separate location where marking material may be supplied to the surface of an image receiving substrate, higher quality, higher resolution, denser images can be formed the more closely spaced each of the individual channels is from each other. In this regard, the channels may be made to have an average spacing distance between adjacent channels of from, for example, about 0.01 μm to about 1,000 μm, such as from about 0.1 μm to about 1,000 μm or from about 0.1 μm to about 100 μm. Any suitable technique may be used to form the channels in the layer. For higher resolution printing members having more closely spaced channels, known photolithographic methods may be used to form the channels within the layer. The total number of channels in the sheet may be from about 100 to about 100,000,000 such as from about 10,000 to about 75,000,000. For example, when the reimageable printing member has a size appropriate for printing letter size paper (for example, 8½ by 11 paper), a number of channels in the reimageable printing member may be from about 50,000 to about 50,000,000.

In embodiments, the channels may extend all the way through the thickness of the layer so as to be through holes. In alternative embodiments, the channels may be made to extend to a depth within the layer without extending all the way through the layer. In embodiments, either the channels do not extend all the way through the layer or the layer at the side of the member opposite the imaging side is made to include a base that closes the channel on such side. The channels are to remain open on the imaging side of the member. In this manner, marking material contained in the channel may be ejected from the channel on the open side to an image receiving substrate positioned opposite the imaging side of the printing member.

The channels are to contain marking materials, for example inks or toner particles, therein. Each of the channels may be described as corresponding to a pixel of an image to be formed by the printing member. As such, although the channels may have any size and shape, the channels should have an average width or diameter that can accommodate marking materials therein. In addition, as each channel can supply marking material to a separate location on the surface of a substrate to be printed, higher quality, higher resolution, denser images can be formed the more closely spaced each of the individual channels is from each other.

Any suitable technique may be used to form the channels in the layer. For example, a bulk micromachining technique may be used for channel fabrication in polymer films. For higher resolution printing members having more closely spaced channels, known photolithographic methods may be used to form the channels within the layer, with photoresist polymeric materials being used with the photolithography technique.

As the material for the layer, in embodiments the layer may be comprised of a non-conductive material and/or a non-magnetic material so that the material of the layer does not substantially interfere with application of the field that causes movement of the marking materials within the channels of the layer. In embodiments, the layer is comprised of a suitable polymer or plastic material, which may be any polymer or plastic material. Suitable materials include, for example, polycarbonates, polystyrenes, polysulfones, polyethersulfones, polyarylsulfones, polyarylethers, polyolefins, polyacrylates, polyvinyl derivatives, cellulose derivatives, polyurethanes, polyamides, polyimides, polyesters, silicone resins, epoxy resins and the like. Copolymer materials such as polystyrene-acrylonitrile, polyethylene-acrylate, vinylidenechloride-vinylchloride, vinylacetate-vinylidene chloride, and styrene-alkyd resins may also be used. The copolymers may be block, random, or alternating copolymers.

Examples of polycarbonates include, for example, poly(bisphenol-A-carbonates) and polyethercarbonates obtained from the condensation of N,N′-diphenyl-N,N′-bis(3-hydroxy phenyl)-[1,1′-biphenyl]-4,4′-diamine and diethylene glycol bischloroformate.

Examples of polystyrenes include, for example, polystyrene, poly(bromostyrene), poly(chlorostyrene), poly(methoxystyrene), poly(methylstyrene) and the like.

Examples of polyolefins include, for example, polychloroprene, polyethylene, poly(ethylene oxide), polypropylene, polybutadiene, polyisobutylene, polyisoprene, and copolymers of ethylene, including poly(ethylene/acrylic acid), poly(ethylene/ethyl acrylate), poly(ethylene/methacrylic acid), poly(ethylene/propylene), poly(ethylene/vinyl acetate), poly(ethylene/vinyl alcohol), poly(ethylene/maleic anhydride) and the like.

Examples of polyacrylates include, for example, poly(methyl methacrylate), poly(cyclohexyl methacrylate), poly(n-butyl methacrylate), poly(sec-butyl methacrylate), poly(isobutyl methacrylate), poly(tert-butyl methacrylate), poly(n-hexyl methacrylate), poly(n-decyl methacrylate), poly(lauryl methacrylate), poly(hexadecyl methacrylate), poly(isobomyl methacrylate), poly(isopropyl methacrylate), poly(isodecyl methacrylate), poly(isooctyl methacrylate), poly(neopentyl methacrylate), poly(octyl methacrylate), poly(n-propyl methacrylate), poly(phenyl methacrylate), as well as the corresponding acrylate polymers. Other examples include, for example, poly(acrylamide), poly(acrylic acid), poly(acrylonitrile), poly(benzylacrylate), poly(benzylmethacrylate), poly(2-ethylhexyl acrylate), poly(triethylene glycol dimethacrylate). Commercially avaliable examples of these materials include acrylic and methacrylic ester polymers such as ACRYLOID™ A10 and ACRYLOID™ B72, polymerized ester derivatives of acrylic and alpha-acrylic acids both from Rohm and Haas Company, and LUCITE™ 44, LUCITE™ 45 and LUCITE™ 46 polymerized butyl methacrylates from Du Pont Company.

Derivatives, in embodiments, refers to resins derived from a polymer component. The polymer component is typically incorporated into the derivative. Thus, examples of polyvinyl derivatives include, for example, poly(vinyl alcohol), poly(vinyl acetate), poly(vinyl chloride), poly(vinyl butyral), poly(vinyl fluoride), poly(vinyl pyridine), poly(vinyl pyrrolidone), poly(vinyl stearate) and the like. Commercially available polyvinyl derivatives include chlorinated rubber such as PARLON™ from Hercules Powder Company; copolymers of polyvinyl chloride and polyvinyl acetate such as Vinylite VYHH and VMCH from Bakelite Corporation, and alkyd resins such as GLYPTAL™ 2469 from General Electric Co.

Examples of polyurethanes include, for example, aliphatic and aromatic polyurethanes like NEOREZ™ 966, NEOREZ™ R-9320 and the like, manufactured by NeoResins Inc., copolymers of polyurethanes with polyethers and polycarbonates like THECOTHANE®, CARBOTHANE®, TECHOPHYLIC® manufactured by Thermadics in Wilmington, Mass. (USA), BAYDUR® and BAYFIT®, BAYFLEX® and BAYTEC® polyurethane polymers manufactured by Bayer, and the like.

Examples of polyamides include, for example, Nylon 6, Nylon 66, TACTEL™ which is a registered mark of DuPont, modified polyamides like ARLEN™ from Mitsui Chemicals and TORLON®, and the like.

Examples of polyesters include, for example, poly(ethylene terepthalate), poly(ethylene napthalate) and the like.

Examples of silicone resins include, for example, polydimethylsiloxane, DC-801, DC804, and DC-996, all manufactured by the Dow Corning Corp. and SR-82, manufactured by GE Silicones. Other examples of silicone resins include copolymers such as silicone polycarbonates, that can be cast into films from solutions in methylene chloride. Such copolymers are disclosed in U.S. Pat. No. 3,994,988. Other examples of silicone resins include siloxane modified acrylate and methacrylate copolymers such as described in U.S. Pat. Nos. 3,878,263 and 3,663,650, methacryl silanes such as COATOSIL® 1757 silane, SILQUEST®A-174NT, SILQUEST®A-178, and SILQUEST®Y-9936 and vinyl silane materials such as COATOSIL® 1706, SILQUEST® A-171, and SILQUEST®A-151 all manufactured by GE-Silicones. Also, solvent-based silicone coatings such as UVHC3000, UVHC8558, and UVHC8559, also manufactured by GE-Silicones, may be used. Aminofunctional silicones may be combined with other polymers to create polyurethanes and polyimides. Examples of aminofunctional silicones include, for example, DMS-A11, DMS-A12, DMS-A15, DMS-A21, and DMS-A32, manufactured by Gelest Inc. Silicone films can also be prepared via RTV addition cure of vinyl terminated polydimethylsiloxanes, as described by Gelect Inc.

Another example of silicone-based coating binders is a cured elastomer derived from the SYLGARD® line of silicone materials. Examples of such materials include SYLGARD® 182 SYLGARD® 184 and SYLGARD® 186, available from Dow Coming.

Examples of epoxy resins include, for example, cycloaliphatic epoxy resins and modified epoxy resins like for example UVACURE 1500 series manufactured by Radcure Inc.; bisphenol-A based epoxy resins like for example D.E.R. 661, D.E.R. 671 and D.E.R. 692H all available at Dow Corning Company. Other examples include aromatic epoxy acrylates like LAROMER™ EA81, LAROMER™ LR 8713 and LAROMER™ LR9019, and modified aromatic epoxy acrylate like LAROMER™ LR 9023, all commercially available from BASF.

Examples of commercially available photoresist polymers suitable for fabrication of channels by photolithography include, for example, KTFR from Kodak comprised of a bis-aryldiazide photosensitive cross-linking agent which absorbs in the near UV, with a polyisoprene cyclized polymer to provide the necessary film-forming and adhesion properties; dry-film photoresists like for example WB2000 and WB3000 series and MX1000, MX3000 and MX9000 series all from DuPont; multifunctional glycidyl ether derivative of bisphenol-A novolac, available from Shell Chemical and known as EPON® resin SU-8; and POWDERLINK® 1174 from Cytek Industries, Inc.

In embodiments, the thickness of the layer may vary and for example, the thickness may be as thin as, for example, about 2 μm or as thick as, for example, about 4 cm. A thicker plate is advantageous because it allows printing a larger number of pages before the plate needs to be refilled with marking particles.

Also associated with the layer is a field generator. A field generator in embodiments refers to a device or unit that generates a field such as an electric field, magnetic field, combinations thereof and the like. As examples, mention may be made of electrodes that can generate an electric field and/or a magnetic field, and of magnetic field generators that can generate an electric field. Two or more different types of field generators may be used in a printing member.

The field generator in embodiments is associated with the layer such that the multiplicity of channels therein are individually addressable by the field generator. In this manner, each of the channels is capable of being separately addressed, and thus marking materials may be moved out of the channels and onto an image receiving substrate at desired locations to form a desired image.

The field generator may be associated with the channels in any suitable design. In embodiments, the field generator may located on a side of the layer comprised of the channels that is opposite the side to which the channels are to be open. Individual field generating units may be located on or in the layer at positions corresponding to the location of each of the multiplicity of channels. For example, electrode units may be located in or on the layer at each of the channels. In embodiments, the field generator may comprise a multiplicity of separate units each associated with a different one of the multiplicity of channels. The units may be located anywhere around or under the multiplicity of channels. In embodiments, the units are located on a side of the layer opposite a side to which the channels are open. For example, an array of electrodes may be located on the layer on a side that is opposite the side to which the channels are open.

Reference will now be made to the Figures in describing embodiments.

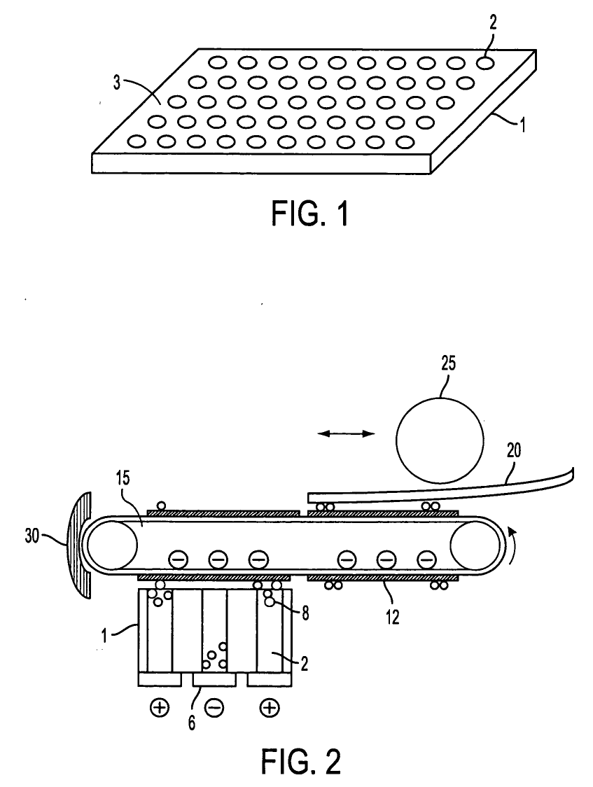

FIG. 1 illustrates an example layer suitable for use in the reimageable printing member. In particular, FIG. 1 shows a porous layer 1 having a multiplicity of channels 2 therein. The layer includes a side 3 to which the channels are open.

FIG. 2 illustrates a flexographic printing system using the reimageable printing member. The operation of the printing member described herein in a flexographic printing system will be described with reference to FIG. 2. For illustration purposes, the FIG. 2 embodiment is shown with electrodes for generating an electric field and/or magnetic field. However, arrays of magnets for generating a magnetic field may equally be used in place of or in conjunction with electrodes, for example where the marking material includes magnetic materials therein.

In FIG. 2, the image to be transferred to the substrate 20 is created by using an array of electrodes 6, associated with layer 1, which make up a bottom electrode. Marking particles 8 are made to move within a channel 2 towards the open side 3 of the layer 1 via an electric field generated by the electrode associated with that channel. The marking particles are made to move onto an image receiving substrate 12 at locations corresponding to the image to be formed. In this flexographic system embodiment, the image receiving substrate 12 is a top electrode layer such as a plate that acts as an intermediate transfer layer or plate, the image formed thereon subsequently being transferred to substrate 20 to be printed.

As the top electrode plate, any material may be used. For electric field applications, it may be suitable to use a conductive or semi-conductive material as the top electrode plate. Specific examples of electrode materials may include copper, silver and other metals, indium-tin oxide and the like. The top electrode plate may be made to have a charge, for example a negative charge as shown in FIG. 2, by any suitable method. Applying a charge to the top electrode plate may assist in the transfer of the marking material from the channels of the printing member to the surface of the top electrode plate.

While FIG. 2 illustrates use of a top electrode plate in transferring the image to substrate 20, in embodiments, the image may be formed directly on a substrate 20 to be printed using the printing member. Further, in embodiments, the top electrode member may take another form besides as a plate, for example a drum form.

The reimageable member may be used for printing a desired number of identical prints. For example, successive top electrode members may be brought into position over the reimageable member, and the same image transferred thereto by the reimageable member in the manner discussed below. The reimageable member may also readily be used to form a different image on successive plates, for example via manipulation of different channels with application of the field. The cycle may be repeated many times.

At an imaging station of the system, an image receiving substrate, here a top electrode plate, is brought over the reimageable printing plate. In embodiments, locating the image receiving substrate over the reimageable printing member refers to the substrate being positioned above the imaging surface, which is the side to which the channels are open, of the printing member. Although the image receiving substrate may contact the surface of the printing member, such is not required. At the imaging station, marking materials within the channels of the reimageable printing member are moved by application of a field to which the materials respond, for example an electric field for marking materials capable of having a triboelectric charge, a magnetic field for marking materials containing magnetic materials, combinations thereof and the like. In FIG. 2, the marking materials are illustrated as electrically charged and sensitive to the direction of an applied electric field, for example a DC current. The image to be transferred onto the substrate is created with reimageable member by using an array of electrodes 6, which may be described as corresponding to pixels. Pixels can be independently turned ON or OFF by using the electric field. If the ON state is defined as the situation when marking materials are moved to the top of the reimageable member, then all the pixels needed to create the image are turned in the ON state. All other marking materials are made to stay within the channels, and thus these pixels are in the OFF state.

In FIG. 2, the top electrode plates are shown to be upon a belt 15. The belt rotates counterclockwise in the illustrated embodiment. At the imaging station, the belt is shown to be made to have a negative charge. Application of a charge to the belt can assist in the transfer of marking material to the image receiving substrate on the belt. In FIG. 2, because the belt has a negative charge, the ON state is when an electrode associated with a channel applies a positive charge, thereby driving the marking materials therein toward the top of the reimageable member and to the top electrode plate located thereover. A pixel is in the OFF state when it has either no charge or a negative charge, so that marking materials in that channel do not move out of the channel.

Thus, in FIG. 2, printing is effected at the imaging station in the two pixels at the edges of the reimageable member (where particles are on the top) but not at the pixel in the middle particles are on the bottom). In this example, the marking particles are positively charged.

The top electrode on the flexographic belt does not need to be made of pixels. It can be made of a continuous electrode plate as shown in FIG. 2. One or more top electrode surfaces can be used on the belt. Using more than one top electrode plate can increase the speed and productivity of printing.

Following imaging at the imaging station, the plate bearing the image is moved via the belt to an image transfer station. Here, he image is transferred onto substrate 20 from the top electrode plate 12, the plate 12 being brought into contact with the substrate 20 to be printed. To ensure high quality of printing, a top drum 25 may be used for pressing the substrate 20 against the electrode plate on the belt, when the image is transferred onto the substrate. The top drum may be heated in order to fix the image onto the substrate. This may be particularly useful in the case when toner particles are being used as the marking material, since toner needs to be fused in order to be permanently fixed on the substrate. Alternatively, a flat plate can be used instead of a top drum.

As substrate 20 to be printed, any substrate material may be used. As examples, mention may be made of paper, cardboard, plastics such as transparency sheets, and the like.

After the image is transferred, the top plate may be cleaned from remaining traces of marking materials at a cleaning station 30. Cleaning station can include, for example, a brush, although any suitable cleaning method and device may be used. In addition, the top surface of the reimageable member may be cleaned between transfers of an image to the top electrode plate or substrate. Again, any suitable method and device may be used for cleaning the top surface of the reimageable member.

While in FIG. 2 a belt system is illustrated, in embodiments, use may be made of a drum instead of a belt, and the process occurs in a similar way.

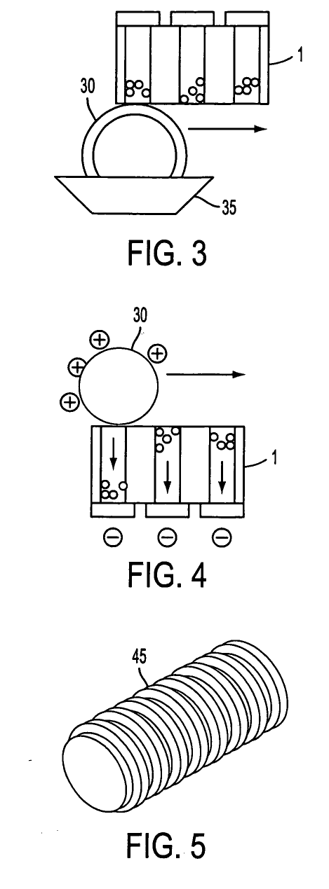

FIGS. 3-5 illustrate methods of filling the channels of the reimageable printing member with marking materials. At any point during the image forming process, the reimageable member may be refilled with marking materials. One method for refilling the channels of the reimageable member with additional marking materials comprises having a reservoir containing additional marking material, in the proximity of the reimageable member, from where the marking materials are directed to the channels of the reimageable member, for example by using appropriate electric fields and/or magnetic fields.

Another method for refilling the channels with marking materials is shown in FIG. 3 and comprises in having a transfer roll 30, which is immersed in a bath or reservoir 35 containing marking materials. The roll is put in contact with the reimageable member, in particular in contact with the surface of the member on the side on which the channels are open. The roll is then allowed to spin and to roll over the surface of the reimageable member, placing the marking materials at the top of the channels of the reimageable member. The marking materials may then be allowed to fill into the channels by natural forces. To assist the filling of the marking materials into the channels, the materials may be assisted in movement through application of an appropriate field that moves the marking materials. For example, as shown in FIG. 4, the marking materials may be made to have a charge such as a positive charge or a negative charge, and the electrodes made to impose an opposite charge, thereby moving the deposited marking materials to the bottom of the channels of the reimageable member.

The transfer roll may have spaced channels 45 therein, for example as shown in FIG. 5, which channels on the transfer roll allow for uniform distribution and, subsequently, transfer of marking material to inside the channels of the reimageable member. When ink is used as the marking material, the transfer roll picks up the ink by capillarity. When dry toner particles are used, the transfer roll may be charged with opposite charge (for example a negative charge on the roll when positive marking particles are used) in order to move the particles from the reservoir to the transfer roll. The release of the toner inside the holes or channels of the reimageable member is achieved by charging the transfer roll with the same charge as the toner particles.

Marking materials that may be used herein include any suitable colorant material, including inks and dry toners. The marking materials may have any desired color, including the conventional colors of black, magenta, cyan and yellow. The marking materials may have any suitable composition, and any toner or ink composition may be used. As but a few examples of colorants for the marking material, mention may be made of dyes and pigments, such as carbon black (for example, REGAL 330™), magnetites, phthalocyanines, HELIOGEN BLUE L6900, D6840, D7080, D7020, PYLAM OIL BLUE, PYLAM OIL YELLOW, and PIGMENT BLUE 1, all available from Paul Uhlich & Co., PIGMENT VIOLET 1, PIGMENT RED 48, LEMON CHROME YELLOW DCC 1026, E.D. TOLUIDINE RED, and BON RED C, all available from Dominion Color Co., NOVAPERM YELLOW FGL and HOSTAPERM PINK E, available from Hoechst, CINQUASIA MAGENTA, available from E.I. DuPont de Nemours & Company, 2,9-dimethyl-substituted quinacridone and anthraquinone dyes identified in the Color Index as CI 60710, CI Dispersed Red 15, diazo dyes identified in the Color Index as CI 26050, CI Solvent Red 19, copper tetra(octadecyl sulfonamido)phthalocyanine, x-copper phthalocyanine pigment listed in the Color Index as CI 74160, CI Pigment Blue, Anthrathrene Blue, identified in the Color Index as CI 69810, Special Blue X-2137, diarylide yellow 3,3-dichlorobenzidene acetoacetanilides, a monoazo pigment identified in the Color Index as CI 12700, CI Solvent Yellow 16, a nitrophenyl amine sulfonamide identified in the Color Index as Foron Yellow SE/GLN, CI Dispersed Yellow 33 2,5-dimethoxy-4-sulfonanilide phenylazo-4′-chloro-2,5-dimethoxy acetoacetanilide, Permanent Yellow FGL, Pigment Yellow 74, B 15:3 cyan pigment dispersion, commercially available from Sun Chemicals, Magenta Red 81:3 pigment dispersion, commercially available from Sun Chemicals, Yellow 180 pigment dispersion, commercially available from Sun Chemicals, colored magnetites, such as mixtures of MAPICO BLACK™ and cyan components, and the like, as well as mixtures thereof. Other commercial sources of pigments available as aqueous pigment dispersion from either Sun Chemical or Ciba include Pigment Yellow 17, Pigment Yellow 14, Pigment Yellow 93, Pigment Yellow 74, Pigment Violet 23, Pigment Violet 1, Pigment Green 7, Pigment Orange 36, Pigment Orange 21, Pigment Orange 16, Pigment Red 185, Pigment Red 122, Pigment Red 81:3, Pigment Blue 15:3, and Pigment Blue 61, and other pigments that enable reproduction of the maximum Pantone color space. Mixtures of colorants can also be employed.

In addition, the marking materials may be made to have a property suitable for manipulation by the field generated by the field generator of the reimageable member. For example, in embodiments, the materials may be capable of carrying a charge such that the marking materials are manipulatable by application of an electric field, and/or the materials may have magnetic materials therein such that the marking materials are manipulatable by application of an electric field or a magnetic field.

The above-described system can be extended to the printing of multicolor images on the desired substrate. Such may be achieved, for example, by passing of the substrate to be printed through multiple reimageable members, each of the reimageable members containing particles of a single color different from colors applied by the other reimageable members. Alternatively, multicolor printing may be obtained by using a single reimageable member that is filled successively with colored marking materials of different colors.

Although a main use of the reimageable member described herein is in printing images on substrates via flexography, the use of the reimageable member is not limited solely to flexographic applications. The reimageable member may be used in any printing operation where printing is done using a printing member such as a plate, for example printing using direct marking engines. In such devices, the image receiving substrate to be printed is located over the reimageable printing member at an imaging station of the engine, and the image formed on the substrate in the same manner as described above such as with respect to FIG. 2. The reimageable printing member may also be used in offset systems.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

What is claimed is:

1. A reimageable printing member comprising a layer having a multiplicity of channels, the layer having an open side to which the multiplicity of channels are open, and wherein the reimageable printing member further includes a field generator, the field generator associated with the multiplicity of channels and generating an electric field, a magnetic field or both, and wherein the multiplicity of channels are individually addressable by the field generator.

2. The reimageable printing member according to claim 1, wherein the field generator comprises an electrode and generates an electric field.

3. The reimageable printing member according to claim 1, wherein the field generator comprises a layer on a surface of the layer opposite the open side of the layer and includes separate addressable locations for individually addressing the multiplicity of channels.

4. The reimageable printing member according to claim 1, wherein the field generator includes separate units each associated with a different one of the multiplicity of channels, the separate units being located on a surface of the layer opposite the open side of the layer.

5. The reimageable printing member according to claim 1, wherein the multiplicity of channels include a marking material therein.

6. The reimageable printing member according to claim 5, wherein the marking material is manipulated to move by the electric field, the magnetic field or both generated by the field generator.

7. The reimageable printing member according to claim 1, wherein the multiplicity of channels have an average diameter or width of about 1 μm to about 200 μm and an average spacing between channels is from about 0.1 to about 100 μm.

8. The reimageable printing member according to claim 1, wherein the member is a printing plate.

9. A reimageable printing member comprising a layer having a multiplicity of channels, wherein the channels are open on one side of the layer, and wherein the layer includes, at an opposite side from the open side of the layer, an electrode unit or a magnetic field generating unit.

10. The reimageable printing member according to claim 9, wherein the layer includes an electrode unit.

11. The reimageable printing member according to claim 9, wherein the electrode unit or magnetic field generating unit comprises a layer on the side of the layer opposite the open side of the layer, the layer being individually addressable at each of the multiplicity of channels.

12. The reimageable printing member according to claim 9, wherein the electrode unit or magnetic field generating unit are comprised of a multiplicity of separate units each associated with a different one of the multiplicity of channels.

13. The reimageable printing member according to claim 9, wherein the multiplicity of channels include a marking material therein.

14. The reimageable printing member according to claim 13, wherein the marking material is manipulated to move by the field generated by the electrode unit and/or the magnetic field generating unit.

15. The reimageable printing member according to claim 9, wherein the multiplicity of channels have an average diameter or width of about 1 μm to about 200 μm and an average spacing between channels is from about 0.1 μm to about 100 μm.

16. The reimageable printing member according to claim 9, wherein the member is a printing plate.

17. A direct marking engine including the reimageable printing member of claim 9.

18. A flexographic printing system including the reimageable printing member of claim 9.

19. A method of forming an image with a reimageable printing member comprising a layer having a multiplicity of channels therein, the layer having an open side to which the multiplicity of channels are open, and wherein the reimageable printing member further includes a field generator, the field generator associated with the multiplicity of channels and generating an electric, a magnetic field or both, and wherein the multiplicity of channels are individually addressable by the field generator, the method comprising:
providing the multiplicity of channels with a marking material;
generating an electric field, a magnetic field or both with the field generator associated with selected ones of the multiplicity of channels that correspond to an image to be formed by the reimageable printing member, wherein generation of the field manipulates the marking material in the selected channels to move toward the open side of the layer; and
forming the image on an image receiving substrate brought over the reimageable printing member.

20. The method according to claim 19, wherein the image receiving substrate comprises a top electrode plate.

21. The method according to claim 20, wherein the method further comprises transferring the image on the top electrode plate to a further substrate.

22. The method according to claim 19, wherein the method further comprises cleaning the open side surface following the contact with the image receiving substrate.

23. The method according to claim 19, wherein the method further comprises, following the contact with the image receiving substrate, repeating the generating step with the same reimageable printing member to form a same image or a different image as formed in a prior generating step with the reimageable printing member.

24. The method according to claim 19, wherein the marking material is provided to the multiplicity of channels by contacting the open side of the reimageable printing member with a transfer roll having the marking materials on a surface thereof.
